(19) United States
(12) Patent Application Publication
(10) Pub. No.: US 2025/0123125 A1
(43) Pub. Date: Apr. 17, 2025

(54) INDUCTIVE SENSOR DEVICE WITH INDUCTOR COIL FORMED IN REDISTRIBUTION LAYER (RDL) REGION

(71) Applicant: Microchip Technology Incorporated, Chandler, AZ (US)

(72) Inventors: Anu Ramamurthy, Newbury Park, CA (US); Kevin Mark Smith, Dana Point, CA (US); Bomy Chen, Newark, CA (US)

(73) Assignee: Microchip Technology Incorporated, Chandler, AZ (US)

(21) Appl. No.: 18/413,114

(22) Filed: Jan. 16, 2024

Related U.S. Application Data
(60) Provisional application No. 63/543,606, filed on Oct. 11, 2023.

(51) Int. Cl. G01D 5/20; G01B 7/30

(52) U.S. Cl. CPC G01D 5/20; G01B 7/30

(57) ABSTRACT

An inductive sensor device includes at least one die mounted in or on a substrate, a redistribution layer (RDL) region formed over the at least one die and including multiple RDL metal layers, and at least one inductive coil formed in the RDL region and including at least one conductive coil element formed in at least one RDL metal layer of the multiple RDL metal layers, wherein the at least one die includes sensor circuitry connected to the at least one inductive coil to perform sensor measurements.

### RELATED APPLICATION

This application claims priority to commonly owned U.S. Provisional Patent Application No. 63/543,606 filed Oct. 11, 2023, the entire contents of which are hereby incorporated by reference for all purposes.

### TECHNICAL FIELD

The present disclosure relates to integrated circuit (IC) devices, and more particularly to an inductive sensor device including at least one inductive coil formed in a redistribution layer (RDL) region, and methods of forming such inductive sensor device.

### BACKGROUND

An inductive sensor uses the principle of electromagnetic induction to detect or measure objects. One type of inductive sensor is a proximity sensor or position sensor used to detect the location and/or movement of an object, e.g., a metal object. An inductive position sensor may be constructed on a printed circuit board (PCB), wherein the sensor includes inductor coils formed from conductive traces on the PCB and connected to an integrated circuit, such as a microchip (e.g., a microcontroller) mounted on the PCB. Such a PCB-based inductive position sensor typically occupies a large area (footprint) on the PCB.

There is a need for an improved inductive sensor (e.g., an improved inductive position sensor), for example with a reduced form factor (size) and/or cost as compared with conventional inductive sensors.

### SUMMARY

The present disclosure provides an inductive sensor device including at least one die mounted in or on a substrate, a redistribution layer (RDL) region formed over the die(s), and at least one inductive sensor coil formed in the RDL region. The RDL region may include multiple RDL metal layers alternating with via layers, and the at least one inductive sensor coil may include inductive coil elements formed in one or more of the RDL metal layers. The inductive sensor coil(s) formed in the RDL region may be connected to one or more underlying dies providing respective functionality of the inductive sensor device, e.g., for detecting the position and/or movement of a target object proximate the inductive sensor device. The RDL region may also include (along with the inductive coil element(s)) conductive routing elements to route electrical signals between respective dies in the inductive sensor device and/or between respective die(s) in the inductive sensor device and external electronics. In some examples, the inductive sensor device may be formed as a System-in-Package (SiP).

An inductive sensor device (e.g., embodied in an SiP) as disclosed herein, e.g., including one or more inductive sensor coils formed in an RDL region over one or more dies, may be substantially smaller than a conventional PCB-based inductive sensor. For example, conductive structures in the RDL region may have a pitch in the range of 2-5 microns, as compared with a typical PCB trace pitch of greater than 20 microns.

An inductive sensor device as disclosed herein may be used in various applications, for example in industrial robots, motor, aircraft, and drones, without limitation.

One aspect provides an inductive sensor device including at least one die mounted in or on a substrate; a redistribution layer (RDL) region formed over the at least one die, the RDL region including multiple RDL metal layers, and at least one inductive coil formed in the RDL region, the at least one inductive coil including at least one conductive coil element formed in at least one RDL metal layer of the multiple RDL metal layers, wherein the at least one die includes a sensor circuitry connected to the at least one inductive coil to perform sensor measurements.

In one example, the at least one inductive coil includes respective conductive coil elements formed in at least two RDL metal layers of the multiple RDL metal layers.

In one example, the inductive sensor device includes multiple conductive signal routing elements formed in the RDL region, wherein (a) a respective conductive coil element of the at least one conductive coil element and (b) a respective conductive signal routing element of the multiple conductive signal routing elements are formed in a common RDL metal layer of the multiple RDL metal layers.

In one example, the at least one inductive coil includes a primary coil and at least one secondary coil, and the sensor circuitry include (a) an oscillator connected to the primary coil to generate a magnetic field from the primary coil and (b) a voltage detection circuitry connected to the at least one secondary coil to detect voltages at the at least one secondary coil.

In one example, the at least one secondary coil includes a first secondary coil and a second secondary coil, and the voltage detection circuitry is connected to the first secondary coil and the second secondary coil to detect a first voltage at the first secondary coil and a second voltage at the second secondary coil, and to calculate a ratio of the first voltage to the second voltage.

In one example, the primary coil which includes at least one primary coil element formed in a first RDL metal layer of the multiple RDL metal layers, the first secondary coil includes at least one first secondary coil element formed in a second RDL metal layer of the multiple RDL metal layers, and the second secondary includes at least one second secondary coil element formed in a third RDL metal layer of the multiple RDL metal layers.

In one example, the inductive sensor device comprises a linear position sensor.

In one example, the inductive sensor device comprises a rotation sensor.

In one example, the inductive sensor device is formed as a system-in-package (SiP) including the at least one die mounted in or on the substrate, the RDL region, and the at least one inductive coil formed in the RDL region.

In one example, the at least one die includes a first die and a second die, and the RDL region includes at least one conductive routing element defining a conductive connection between the first die and the second die.

In one example, the at least one die includes an analog die and a digital die.

In one example, the inductive sensor device includes a wireless antenna including an antenna coil including at least one conductive coil element formed in the RDL region.

One aspect provides a method, including arranging at least one die on a carrier, the at least one die including a sensor circuitry, depositing an encapsulant over the at least one die to form a substrate supporting the at least one die, and forming an RDL region including multiple RDL metal layers over the at least one die, wherein forming the RDL region includes forming at least one inductive coil including at least one conductive coil element in at least one RDL metal layer of the multiple RDL metal layers, and wherein the at least one inductive coil is connected to the sensor circuitry in the at least one die.

In one example, forming the RDL region including multiple RDL metal layers includes forming multiple RDL metal layers alternating with multiple RDL via layers, and forming respective conductive coil elements of the at least one inductive coil includes forming respective conductive coil elements in at least two respective RDL metal layers of the multiple RDL metal layers.

In one example, the method includes forming multiple conductive signal routing elements in the RDL region, wherein (a) a respective conductive coil element of the at least one conductive coil element and (b) a respective conductive signal routing element of the multiple conductive signal routing elements are formed in a common RDL metal layer of the multiple RDL metal layers.

In one example, forming the at least one inductive coil includes (a) forming a primary coil in a respective RDL metal layer of the multiple RDL metal layers and (b) forming at least one secondary coil in at least one other respective RDL metal layer of the multiple RDL metal layers.

In one example, forming the at least one inductive coil including at least one conductive coil element in at least one RDL metal layer of the multiple RDL metal layers includes forming at least one primary coil element of a primary coil in a first RDL metal layer, forming at least one first secondary coil element of a first secondary coil in a second RDL metal layer, and forming at least one second secondary coil element of a second secondary coil in a third RDL metal layer.

In one example, the at least one die includes a first die and a second die, and the method includes forming at least one conductive routing element in the RDL region to conductively connect the first die to the second die.

In one example, the method includes forming at least one conductive antenna coil element of a wireless antenna in the RDL region.

One aspect provides a method, including arranging an object relative to an inductive sensor device, wherein the inductive sensor device includes at least one die including sensor circuitry, an RDL region including multiple RDL metal layers formed over the at least one die, a primary coil and at least one secondary coil formed in the RDL region, wherein the sensor circuitry includes an oscillator connected to the primary coil and a voltage detection circuitry connected to the at least one secondary coil, generating by the oscillator a magnetic field from the primary coil, detecting by the voltage detection circuitry voltages at the at least one secondary coil, and determining a position or a movement of the object based at least on the detected voltages.

In one example, the at least one secondary coil includes a first secondary coil and a second secondary coil, and the method includes detecting by the voltage detection circuitry a first voltage at the first secondary coil and a second voltage at the second secondary coil, calculating a ratio of the first voltage to the second voltage, and determining the position or movement of the object based at least on the calculated voltage ratio.

One aspect provides an inductive sensor device including at least one die mounted in or on a substrate, an RDL region formed over the at least one die, the RDL region including multiple RDL metal layers, and a primary coil including a primary coil element formed in a first RDL metal layer of the multiple RDL metal layers, a first secondary coil including a first secondary coil element formed in a second RDL metal layer of the multiple RDL metal layers, and a second secondary coil including a second secondary coil element formed in a third RDL metal layer of the multiple RDL metal layers, wherein the at least one die includes sensor circuitry connected to the primary coil, the first secondary coil, and the second secondary coil.

In one example, the sensor circuitry includes (a) an oscillator to generate a magnetic field from the primary coil, and (b) a voltage detection circuitry to detect a first voltage at the first secondary coil and a second voltage at the second secondary coil, calculate a ratio of the first voltage to the second voltage, and determine a position or movement of a target object based at least on the calculated ratio of the first voltage to the second voltage.

### BRIEF DESCRIPTION OF THE DRAWINGS

Example aspects of the present disclosure are described below in conjunction with the figures, in which:

FIGS. 1A and 1B show a top view and cross-sectional side view, respectively, of an example inductive sensor device for sensing a target object;

FIG. 2 shows a cross-sectional side view of an example inductive sensor device including an inductive coil with conductive coil elements formed in two RDL metal layers;

FIGS. 3A and 3B show a top view and cross-sectional side view, respectively, of an example inductive sensor device, including a primary coil and two secondary coils, for sensing the position and/or movements of a target object;

FIG. 4A shows an example electronic device including an example inductive sensor device solder bonded to a PCB;

FIG. 4B shows an example electronic device including an example inductive sensor device wire bonded to a PCB;

FIGS. 5A and 5B show an example method of forming the example inductive sensor device shown in FIGS. 3A-3B; and

FIG. 6 shows an example method of determining a position or a movement of a target object using the example inductive sensor device shown in FIGS. 3A-3B.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

Examples of the present disclosure provide an inductive sensor device including at least one die mounted in or on a substrate, an RDL region formed over the die(s), and an inductive sensor coil(s) formed in the RDL region. The inductive sensor coil(s) may be connected to underlying die(s) providing respective functionality of the inductive sensor device, e.g., for detecting the position and/or movement of a target object proximate the inductive sensor device.

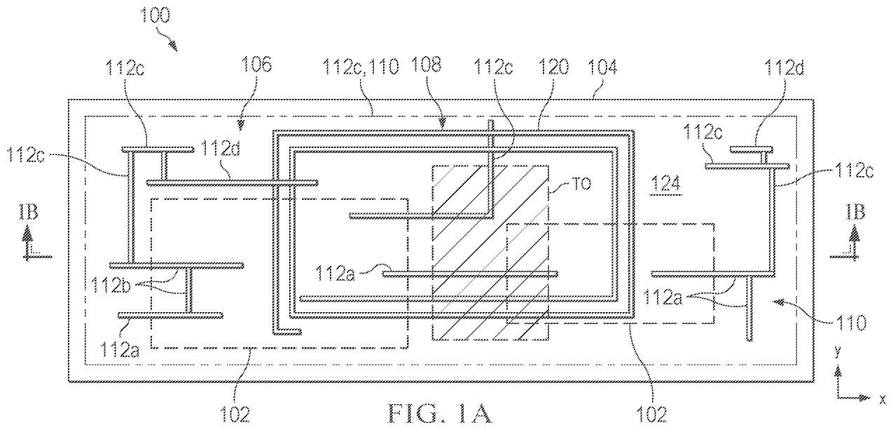

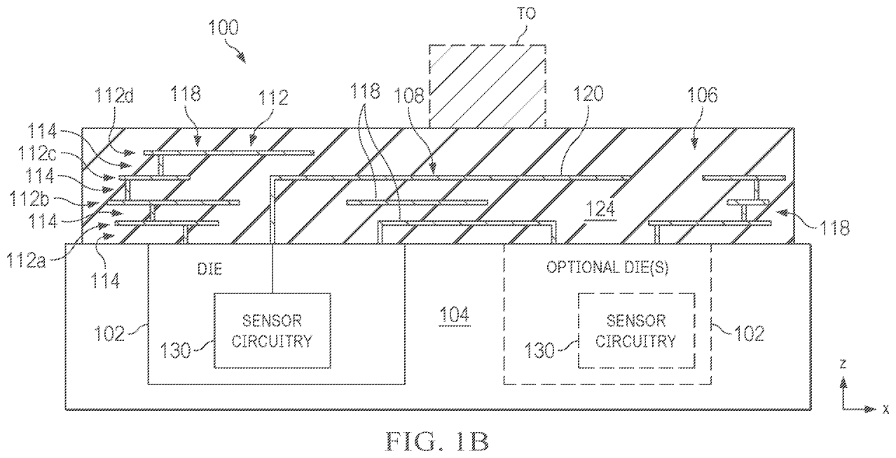

FIGS. 1A and 1B show a top view and cross-sectional side view, respectively, of an example inductive sensor device 100 for sensing a target object TO proximate the inductive sensor device 100. The example inductive sensor device 100 may include one or more dies 102 mounted in or on a substrate 104, a redistribution layer (RDL) region 106 formed over the die(s) 102, and an inductive coil 108 formed in the RDL region 106. The die(s) 102 may include a sensor circuitry 130 providing respective inductive sensor functionality of the inductive sensor device 100. In some examples, the inductive sensor device 100 may comprise a linear position sensor or a rotation sensor, wherein the sensor circuitry 130 may include circuitry for detecting the position and/or movement (e.g., linear and/or rotational position and/or movement) of the target object TO. In other examples, the inductive sensor device 100 may comprise a proximity sensor to detect proximity of an object, a metal detector (e.g., to detect the presence of metal proximate the sensor 100), or any other suitable type of sensor.

In some examples, the sensor circuitry 130 may be provided in a single die 102. In other examples, the sensor circuitry 130 may include circuitry components distributed across two or more dies 102. In some examples, the inductive sensor device 100 device may include at least two different types of dies 102, i.e., a heterogeneous device. For example, the inductive sensor device 100 may include at least one analog die 102 and at least one digital die 102. In some examples, the example inductive sensor device 100 is formed as a system-in-package (SiP).

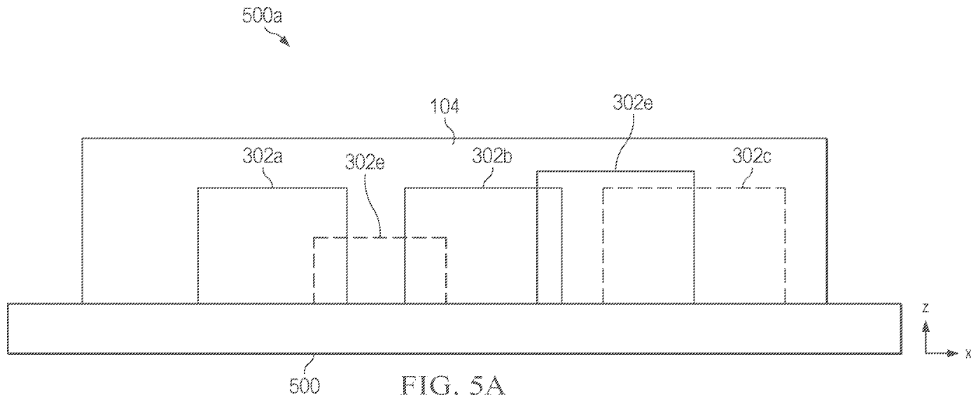

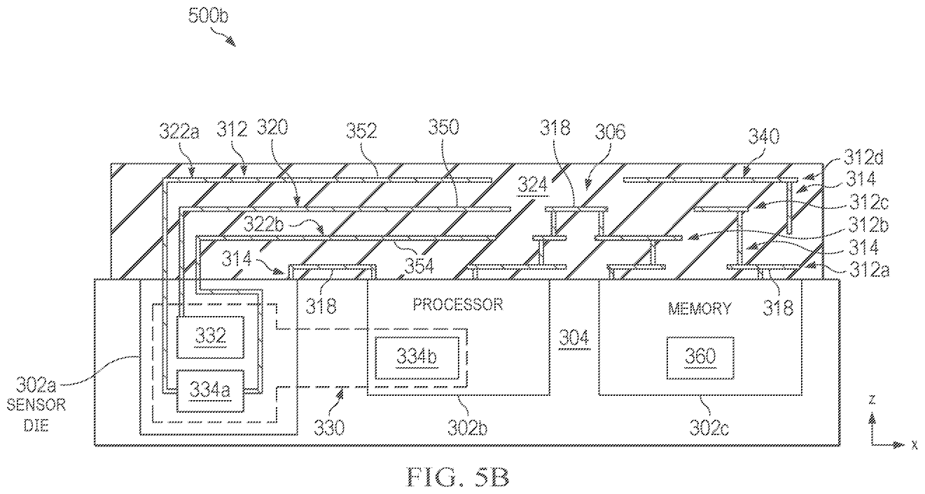

In some examples, the substrate 104 may comprise an encapsulant (e.g., an epoxy) formed over the die(s) during manufacturing of the example inductive sensor device 100, e.g., as discussed below with reference to FIG. 5A.

The RDL region 106 may include multiple RDL metal layers 112 alternating with multiple RDL via layers 114. The example shown in FIG. 1B includes at least four RDL metal layers 112a-112d. Respective RDL metal layers 112 may include laterally-extending RDL elements (e.g., metal elements extending in the x-direction and/or y-direction shown in FIGS. 1A and 1B), and respective RDL via layers 114 may include vertically-extending via elements (e.g., metal vias extending in the z-direction shown in FIGS. 1A and 1B). In some examples, laterally-extending RDL elements formed in respective RDL metal layers 112 may include conductive signal routing elements 118 and at least one conductive coil element 120 (discussed below). Conductive elements formed in the RDL region 106 (e.g., signal routing elements 118 and conductive coil element(s) 120 formed in respective RDL metal layers 112, and via elements formed in respective RDL via layers 114) may be at least partially encapsulated by a dielectric region 124, e.g., one comprising or more polymers or other dielectric material(s).

In some examples, RDL elements including conductive signal routing elements 118 and conductive coil element(s) 120 may be formed with a pitch in the range of 2-5 microns, which may be significantly smaller than a typical PCB trace pitch of greater than 20 microns.

The inductive coil 108 may include at least one conductive coil element 120 formed in at least one RDL metal layer 112. In the example shown in FIGS. 1A-1B, the inductive coil 108 includes a conductive coil element 120 formed in the example RDL metal layer 112c, which conductive coil element 120 may be connected to the sensor circuitry 130 by respective conductive elements, e.g., including respective via elements formed in respective RDL via layers 114. As shown in FIG. 1B, the conductive coil element 120 may be formed in the same RDL metal layer 112c as one or more signal routing elements 118 distinct from the inductive coil 108. In some examples, the conductive coil element 120 may be laser trimmed, e.g., for enhanced precision of the shape, size, and/or location of the conductive coil element 120.

The sensor circuitry 130 connected to the inductive coil 108 may include circuitry to measure at least one characteristic of the target object TO based on interaction between the target object TO and the inductive coil 108. In some examples, the inductive sensor device 100 may comprise a position sensor to measure a position and/or movement of the target object TO. In some examples, the inductive sensor device 100 may comprise a linear position sensor, e.g., to measure the position and/or linear displacements of the target object TO in the x-direction and/or y-direction shown in FIG. 1A. In other examples, the inductive sensor device 100 may comprise a rotation sensor, e.g., to measure rotations of the target object TO around the z-axis direction shown in FIG. 1B. In other examples, the inductive sensor device 100 may measure both linear displacements and rotations of the target object TO.

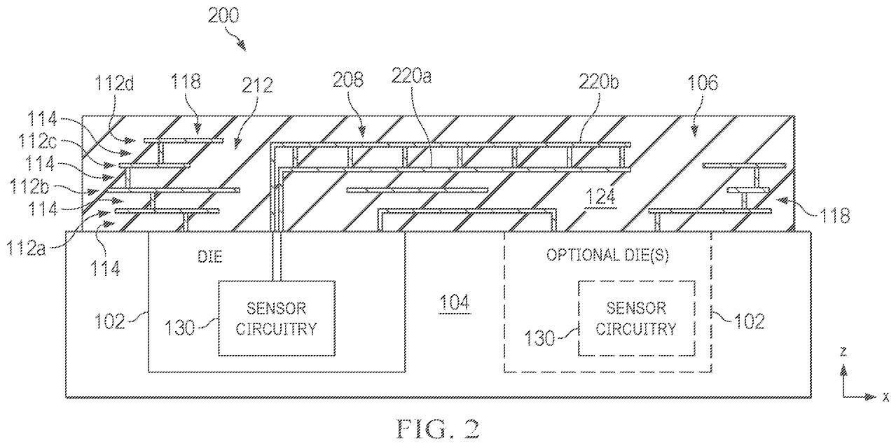

As shown in FIG. 2, in some examples, an inductive coil may include multiple conductive coil elements formed in multiple RDL metal layers 112. FIG. 2 shows a cross-sectional side view of an example inductive sensor device 200 similar to the example inductive sensor device 100 shown in FIGS. 1A-1B, but wherein an inductive coil 208 includes conductive coil elements 220 formed in two RDL metal layers 112, in particular a first conductive coil element 220a formed in RDL metal layer 112c and a second conductive coil element 220b formed in RDL metal layer 112d. The first conductive coil element 220a and second conductive coil element 220b may optionally be conductively connected to one another by via element(s) formed in a respective RDL via layer 114.

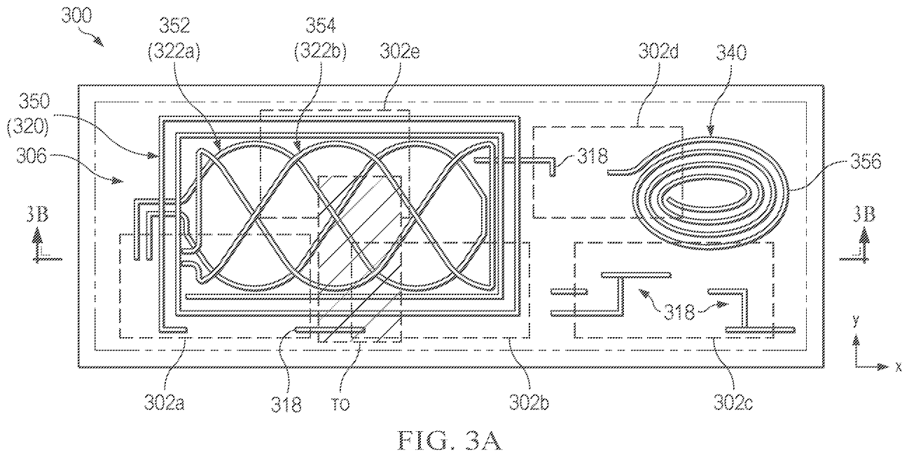

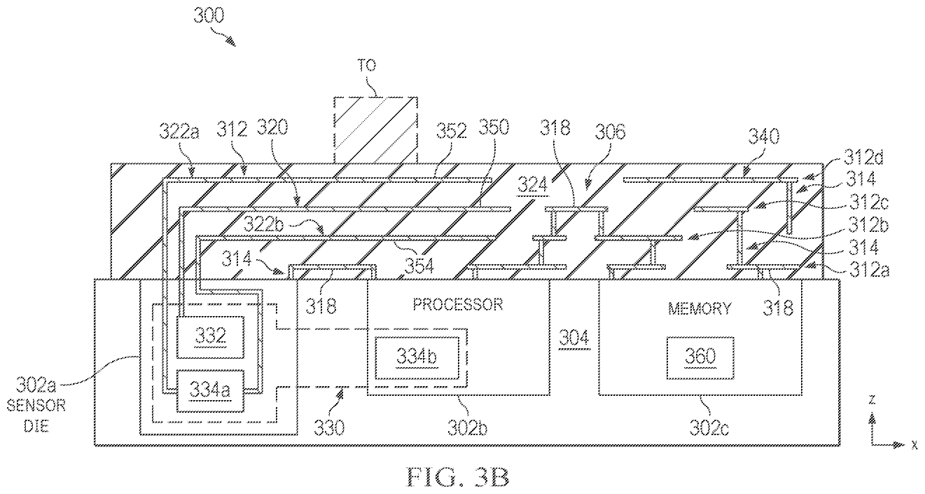

FIGS. 3A and 3B show a top view and cross-sectional side view, respectively, of an example inductive sensor device 300 for sensing the position and/or movements of a target object TO proximate the inductive sensor device 300. Accordingly, the example inductive sensor device 300 may be referred to as a position sensor. The example inductive sensor device 300 includes dies 302a-302e mounted in or on a substrate 304, a redistribution layer (RDL) region 306 formed over the dies 302a-302e, and three inductive coils formed in the RDL region 306, namely a primary coil 320, a first secondary coil 322a, and a second secondary coil 322b. In some examples, the example inductive sensor device 300 is formed as a system-in-package (SiP).

The RDL region 306 may include multiple RDL metal layers 312 alternating with multiple RDL via layers 314. The example shown in FIG. 3B includes at least four RDL metal layers 312a-312d. Respective RDL metal layers 312 may include laterally-extending RDL elements (e.g., metal elements extending in the x-direction and/or y-direction shown in FIGS. 3A and 3B), and respective RDL via layers 314 may include vertically-extending via elements (e.g., metal vias extending in the z-direction shown in FIGS. 3A and 3B). Laterally-extending RDL elements formed in respective RDL metal layers 312 may include conductive signal routing elements 318 and respective conductive coil elements of the primary coil 320, first secondary coil 322a, and second secondary coil 322b. Conductive elements formed in the RDL region 306 (e.g., signal routing elements 318 and conductive coil elements of the primary coil 320, first secondary coil 322a, and second secondary coil 322b formed in respective RDL metal layers 312, and via elements formed in respective RDL via layers 314) may be at least partially encapsulated by a dielectric region 324, e.g., one comprising or more polymers or other dielectric material(s).

In the illustrated example, the primary coil 320 includes a conductive coil element 350 (i.e., a primary coil element 350) formed in the example RDL metal layer 312c, the first secondary coil 322a includes a conductive coil element 352 (i.e., a first secondary coil element 352) formed in the example RDL metal layer 312d, and the second secondary coil 322b includes a conductive coil element 354 (i.e., a second secondary coil element 354) formed in the example RDL metal layer 312b. The conductive coil elements 350, 352, and 354 may be connected to a sensor circuitry 330 by respective conductive elements, e.g., including respective via elements formed in respective RDL via layers 314. In addition, the RDL metal layer 312c, 312d, and 312b in which the conductive coil elements 350, 352, and 354 (respectively) are formed may also include respective signal routing elements 318 distinct from the conductive coil elements 350, 352, and 354, e.g., for communicating electrical signals to and/or from respective dies 302a-302e. In some examples, the respectively conductive coil elements 350, 352, and 354 may be laser trimmed, e.g., for enhanced precision of the shape, size, and/or location of the conductive coil elements 350, 352, and 354.

The illustrated example includes five dies 302a-302e, namely an analog sensor die 302a, a processor 302b, a memory 302c, a wireless transceiver 302d, and additional circuitry 302e, e.g., providing respective functionality of the inductive sensor device 300, e.g., for detecting positions and/or movements of the target object TO. It should be understood that in other examples the inductive sensor device 300 may include any other number and/or type(s) of dies (including a single die in some examples).

The dies 302a-302e may include sensor circuitry 330 to measure at least one characteristic of the target object TO based on interaction between the target object TO and the inductive coils 320, 322a, and 333b, as discussed below. In some examples, the sensor circuitry 330 may be provided in a single die. In other examples, the sensor circuitry 330 may include circuitry components distributed across two or more of the dies 302a-302e.

In the illustrated example, the sensor circuitry 330 includes an oscillator 332 and a voltage detection circuitry 334a/334b. The oscillator 332 may be connected to the primary coil 320 to generate a magnetic field from the primary coil 320. The voltage detection circuitry 334a/334b may include respective voltage detection circuitry 334a provided in the analog sensor die 302a and respective voltage detection circuitry 334b provided in the processor 302b. Voltage detection circuitry 334s provided in the analog sensor die 302a may include analog front end (AFE) electronics to detect (monitor) a first voltage on the first secondary coil 322a and a second voltage on the second secondary coil 322b. Voltage detection circuitry 334b provided in the processor 302b may include (a) circuitry to process the detected first voltage (at the first secondary coil 322a) and second voltage (at the second secondary coil 322b), e.g., including calculating a ratio of the first voltage to the second voltage, and determining a position of the target object TO based on the determined voltage ratio, and (b) circuitry to set and adjust operational settings of the inductive sensor device 300. In some examples, voltage detection circuitry 334b may include circuitry to calculate a ratio of the first voltage to the second voltage, calculate an arctangent of the voltage ratio, and determining a position of the target object TO based on the arctangent of the voltage ratio, e.g., along the x-axis direction shown in FIGS. 3A-3B.

It should be understood that the example implementation of sensor circuitry 330 shown in FIG. 3B is one example only. The sensor circuitry 330 (e.g., including oscillator 332 and voltage detection circuitry 334a/334b) may otherwise be provided in a single die or distributed in multiple dies in any other suitable configuration.

In some examples, the processor 302b may comprise a microcontroller, microprocessor, field programmable gate array (FPGA), digital signal processor (DSP), or application-specific integrated circuit (ASIC), without limitation, to execute logic instructions (e.g., embodied in firmware or software provided in any of the dies 302a-302e) to perform various functions of the inductive sensor device 300. The memory 302c may comprise a non-volatile memory die (e.g., NOR Flash or other Flash memory, ROM, EPROM, or EEPROM, without limitation) and/or volatile memory (e.g., DRAM) to store position measurement data 360 generated by the inductive sensor device 300, sensor settings, and/or other data associated with the inductive sensor device 300.

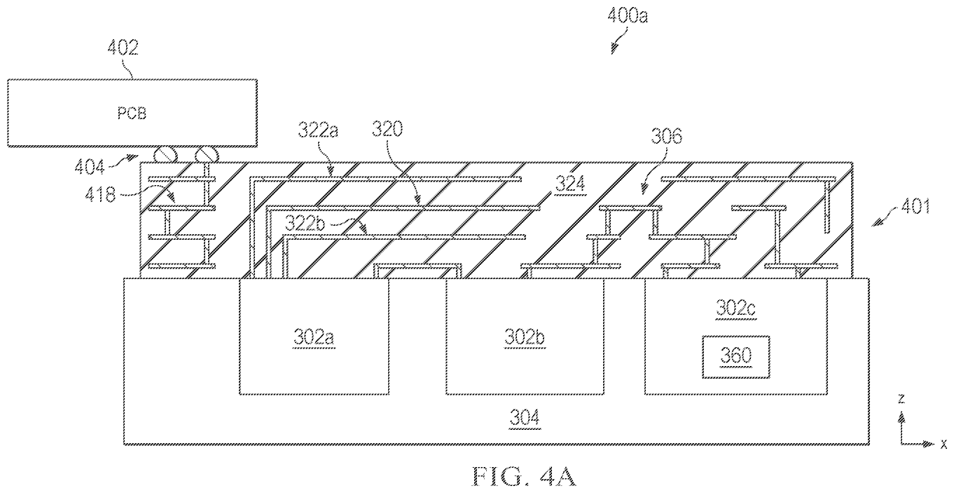

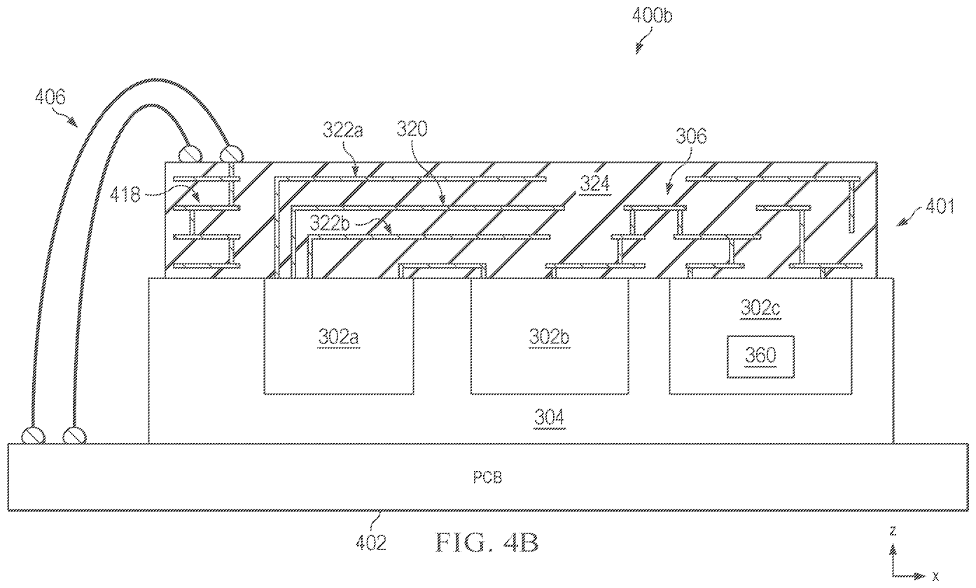

In some examples, the inductive sensor device 300 may include an antenna 340 including a conductive coil element 356 (i.e., an antenna coil element 356) formed in the RDL region 306 and connected to the wireless transceiver 302d. In the illustrated example, the conductive coil element 356 is at least partially formed in the RDL metal layer 312d, which conductive coil element 356 may be connected to the wireless transceiver 304d by respective via elements formed in respective RDL via layers 314. The wireless transceiver 302d may include circuitry to transmit position measurement data 360 to external electronics using the antenna 340 and/or receive respective wireless signals (e.g., signals requesting transmission of position measurement data 360 and/or control signals for controlling an operation of the inductive sensor device 300, without limitation). In other examples, for example as shown in FIGS. 4A and 4B, the inductive sensor device 300 may include a wired connection (e.g., using wire bonds or direct solder bonds to other electronics) to transmit position measurement data 360 to external electronics. The wireless transceiver 302d may include circuitry for communicating in any suitable wireless protocol, e.g., Bluetooth, Bluetooth Low Energy (BLE), or WiFi, without limitation.

FIG. 4A shows an example electronic device 400a including an example inductive sensor device 401 mounted to a printed circuit board (PCB) 402 by solder bonds 404. The example inductive sensor device 401 may be similar to the example inductive sensor device 300 shown in FIGS. 3A-3B and discussed above (with like reference numbers referring to like elements), and may include conductive signal routing elements 418 formed in the RDL region 306 to connect respective circuitry of the inductive sensor device 401 to the PCB 402, e.g., to communicate position measurement data 360 generated by the inductive sensor device 401 to electronics mounted on or otherwise connected to the PCB 402.

FIG. 4B shows an example electronic device 400b including the example inductive sensor device 401 mounted to a PCB 402 by wire bonds 406 to connect respective circuitry of the inductive sensor device 401 to the PCB 402, e.g., to communicate position measurement data 360 generated by the inductive sensor device 401 to electronics mounted on or otherwise connected to the PCB 402.

FIGS. 5A and 5B show an example method of forming the example inductive sensor device 300 shown in FIGS. 3A-3B. As shown in FIG. 5A, dies 302a-302e are arranged (e.g., mounted) on a carrier 500, e.g., comprising an organic laminate substrate or other package substrate. As discussed above regarding FIGS. 3A and 3B, one or more of the dies 302a-302e may include sensor circuitry 330 to detect and process sensor measurements, for example including the oscillator 332 and voltage detection circuitry 334a/334b discussed above. An encapsulant (e.g., an epoxy) may be deposited or otherwise formed over the dies 302a-302e to define the substrate 104 supporting the dies 302a-302e.

As shown in FIG. 5B, the carrier 500 may be removed, and the substrate 104 including dies 302a-302e mounted therein may be inverted (flipped over) for further processing. In particular, the RDL region 306 may be formed over the substrate 104 (including dies 302a-302e), wherein the RDL region 306 includes the multiple RDL metal layers 312 alternating with multiple RDL via layers 314, with the primary coil 320, first secondary coil 322a, and second secondary coil 322b and conductive signal routing elements 318 formed therein (e.g., including conductive coil elements 350, 352, and 354 formed in RDL metal layers 312c, 312d, and 312b, respectively), and wherein the primary coil 320 is connected to the oscillator 332, and the first and second secondary coils 322a, 322b are connected to the voltage detection circuitry 334a provided in the analog sensor die 302a.

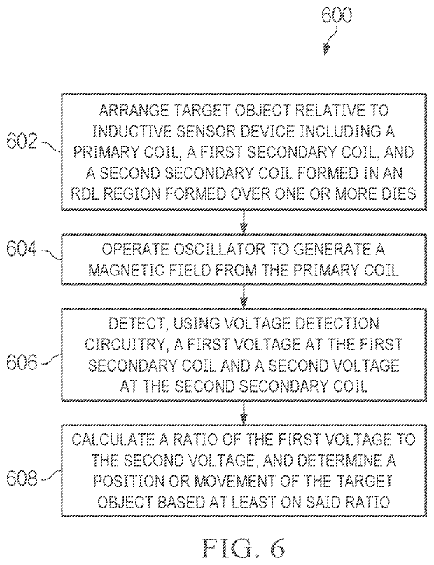

FIG. 6 shows an example method 600 of determining a position or a movement of a target object using the example inductive sensor device 300 shown in FIGS. 3A-3B. At 602, the target object TO is arranged relative to the inductive sensor device 300. As discussed above, the inductive sensor device 300 includes dies 302a-302e provided in the substrate 304, and the primary coil 320, first secondary coil 322a, and second secondary coil 322b formed in the RDL region 306 formed over the dies 302a-302e, wherein the primary coil 320, first secondary coil 322a, and second secondary coil 322b are connected to respective sensor circuitry 330 provided in one or more of the dies 302a-302e. For example, the primary coil 320 may be connected to the oscillator 332, and the first and second secondary coils 322a, 322b may be connected to the voltage detection circuitry 334a provided in the analog sensor die 302a.

At 604, the oscillator may be operated to generate a magnetic field from the primary coil 320. At 606, the voltage detection circuitry 334a may detect (a) a first voltage at the first secondary coil 322a and (b) a second voltage at the second secondary coil 322b. At 608, voltage detection circuitry 334b of the processor die 302b may calculate a ratio of the first voltage to the second voltage, and determine a position or movement of the target object based at least on the calculated voltage ratio. In one example, the voltage detection circuitry 334b may calculate a ratio of the first voltage to the second voltage, calculate an arctangent of the voltage ratio, and determine a position or movement of the target object based at least on the arctangent of the voltage ratio.

Although example embodiments have been described above, other variations and embodiments may be made from this disclosure without departing from the spirit and scope of these embodiments.

1. An inductive sensor device, comprising:
at least one die mounted in or on a substrate;
a redistribution layer (RDL) region formed over the at least one die, the RDL region including multiple RDL metal layers; and
at least one inductive coil formed in the RDL region, the at least one inductive coil including at least one conductive coil element formed in at least one RDL metal layer of the multiple RDL metal layers;
wherein the at least one die includes a sensor circuitry connected to the at least one inductive coil to perform sensor measurements.

2. The inductive sensor device of claim 1, wherein the at least one inductive coil includes respective conductive coil elements formed in at least two RDL metal layers of the multiple RDL metal layers.

3. The inductive sensor device of claim 1, comprising multiple conductive signal routing elements formed in the RDL region, wherein (a) a respective conductive coil element of the at least one conductive coil element and (b) a respective conductive signal routing element of the multiple conductive signal routing elements are formed in a common RDL metal layer of the multiple RDL metal layers.

4. The inductive sensor device of claim 1, wherein:
the at least one inductive coil includes a primary coil and at least one secondary coil; and
the sensor circuitry includes:
an oscillator connected to the primary coil to generate a magnetic field from the primary coil; and
a voltage detection circuitry connected to the at least one secondary coil to detect voltages at the at least one secondary coil.

5. The inductive sensor device of claim 4, wherein:
the at least one secondary coil includes a first secondary coil and a second secondary coil; and
the voltage detection circuitry is connected to the first secondary coil and the second secondary coil to detect a first voltage at the first secondary coil and a second voltage at the second secondary coil, and to calculate a ratio of the first voltage to the second voltage.

6. The inductive sensor device of claim 4, wherein:
the primary coil includes at least one primary coil element is formed in a first RDL metal layer of the multiple RDL metal layers;
the first secondary coil includes at least one first secondary coil element formed in a second RDL metal layer of the multiple RDL metal layers; and
the second secondary includes at least one second secondary coil element formed in a third RDL metal layer of the multiple RDL metal layers.

7. The inductive sensor device of claim 4, wherein the inductive sensor device comprises a linear position sensor.

8. The inductive sensor device of claim 4, wherein the inductive sensor device comprises a rotation sensor.

9. The inductive sensor device of claim 1, wherein the inductive sensor device is formed as a system-in-package (SiP) including the at least one die mounted in or on the substrate, the RDL region, and the at least one inductive coil formed in the RDL region.

10. The inductive sensor device of claim 1, wherein the at least one die includes a first die and a second die; and
the RDL region includes at least one conductive routing element defining a conductive connection between the first die and the second die.

11. The inductive sensor device of claim 1, wherein the at least one die includes an analog die and a digital die.

12. The inductive sensor device of claim 1, comprising an antenna including an antenna coil including at least one conductive coil element formed in the RDL region.

13. A method, comprising:
arranging at least one die on a carrier, the at least one die including sensor circuitry;
depositing an encapsulant over the at least one die to form a substrate supporting the at least one die; and
forming a redistribution layer (RDL) region including multiple RDL metal layers over the at least one die,
wherein forming the RDL region includes forming at least one inductive coil including at least one conductive coil element in at least one RDL metal layer of the multiple RDL metal layers; and
wherein the at least one inductive coil is connected to the sensor circuitry in the at least one die.

14. The method of claim 13, wherein forming the RDL region including multiple RDL metal layers includes forming multiple RDL metal layers alternating with multiple RDL via layers, and forming respective conductive coil elements of the at least one inductive coil includes forming respective conductive coil elements in at least two respective RDL metal layers of the multiple RDL metal layers.

15. The method of claim 13, comprising forming multiple conductive signal routing elements in the RDL region, wherein (a) a respective conductive coil element of the at least one conductive coil element and (b) a respective conductive signal routing element of the multiple conductive signal routing elements are formed in a common RDL metal layer of the multiple RDL metal layers.

16. The method of claim 13, wherein forming the at least one inductive coil includes (a) forming a primary coil in a respective RDL metal layer of the multiple RDL metal layers and (b) forming at least one secondary coil in at least one other respective RDL metal layer of the multiple RDL metal layers.

17. The method of claim 13, wherein forming the at least one inductive coil including at least one conductive coil element in at least one RDL metal layer of the multiple RDL metal layers includes:
forming at least one primary coil element of a primary coil in a first RDL metal layer;
forming at least one first secondary coil element of a first secondary coil in a second RDL metal layer; and
forming at least one second secondary coil element of a second secondary in a third RDL metal layer.

18. The method of claim 13, wherein the at least one die includes a first die and a second die; and
the method includes forming at least one conductive routing element in the RDL region to conductively connect the first die to the second die.

19. An inductive sensor device, comprising:
at least one die mounted in or on a substrate;
a redistribution layer (RDL) region formed over the at least one die, the RDL region including multiple RDL metal layers;
a primary coil including a primary coil element formed in a first RDL metal layer of the multiple RDL metal layers;
a first secondary coil including a first secondary coil element formed in a second RDL metal layer of the multiple RDL metal layers; and
a second secondary coil including a second secondary coil element formed in a third RDL metal layer of the multiple RDL metal layers;
wherein the at least one die includes sensor circuitry connected to the primary coil, the first secondary coil, and the second secondary coil.

20. The inductive sensor device of claim 19, wherein the sensor circuitry includes:
an oscillator to generate a magnetic field from the primary coil; and
a voltage detection circuitry to:
detect a first voltage at the first secondary coil and a second voltage at the second secondary coil;
calculate a ratio of the first voltage to the second voltage; and
determine a position or movement of a target object based at least on the calculated ratio of the first voltage to the second voltage.
